(19) United States
(12) Patent Application Publication
(10) Pub. No.: US 2007/0278063 A1
(43) Pub. Date: Dec. 6, 2007

(54) Unidirectional clutch

(75) Inventor: Tien-Ho Hsu, Hsinchu City (TW)

Correspondence Address: ROSENBERG, KLEIN & LEE, 3458 ELLICOTT CENTER DRIVE-SUITE 101, ELLICOTT CITY, MD, 21043, US

(73) Assignee: Lite-On Technology Corporation

(21) Appl. No.: 11/443,022

(22) Filed: May 31, 2006

(51) Int. Cl. F16D 41/20

(52) U.S. Cl. 192/41 S

(57) ABSTRACT

A unidirectional clutch of the present invention includes a power input unit, a power output unit and a resilient element. The power input unit and the power output unit are coaxially disposed, and a contact mechanism is formed between the power output unit and a power input unit. The power input unit rotates with respect to the power output unit to a certain extent so that power of the power input unit is transmitted to the power output unit. The resilient element is used to provide torque to the power output unit and the power input unit so that the power output unit and the power input unit will be kept in a pre-determined relative position. The unidirectional clutch of the present invention uses minimal components to transmit power in one direction. Cost of the unidirectional clutch is lowered and assembly is simplified.

### BACKGROUND OF THE INVENTION

1. Field of the Invention

The present invention relates to a unidirectional clutch, and in particular, to a simplified design of a unidirectional clutch which is implemented in a variety of gear train or similar transmission mechanism so as to control and transmit power.

2. Description of Related Art

At present, unidirectional clutches implemented in transmission mechanism are used to transmit power of power sources such as motors. When the power sources are turned off, the unidirectional clutches are used to break a transmission train (gear train) between the power source and an actuation apparatus. Thus, the actuation apparatus are still in operation and are not impacted by the power source and the transmission train.

Reference is made to FIG. 1. FIG. 1 illustrates an actuation apparatus 7, a first power source 8 and a second power source 9. The actuation apparatus 7 is disposed between the first power source 8 and the second power source 9. The actuation apparatus 7 has four spur gears 71, 72, 73 and 74 which are respectively used to transmit power to four cylinders 75, 76, 77 and 78.

Both the first power source 8 and the second power source 9 are motors, and power of the power source 8 is transmitted to the spur gear 71 through a power input unit (such as spur gear) 81 and a power output unit (such as spur gear) 82 so that the cylinder 75 is rotated. When the power of the first power source 8 needs to be transmitted to the cylinder 76, the second power source 9 is used to drive the actuation apparatus 7 to rotate. Thus, the spur gear 72 engages with the power output unit 82 so that the power of the first power source 8 is transmitted to the spur gear 72 so as to drive the cylinder 76 to rotate. In this regard, the power of the first power source 8 can be transmitted to the cylinders 75, 76, 77 and 78 so that power switch between the cylinders 75, 76, 77 and 78 is achieved.

When the spur gears 71, 72, 73 and 74 respectively engage with the power output unit 82 during the period of power switch, the first power source 8 comes to stop. Because the gear train between the power output unit 82 and the first power source 8 is engaged and gear reduction ratio is considered, impact force is generated between the spur gears 71, 72, 73 and 74 and the power output unit 82. The spur gears 71, 72, 73 and 74 and the power output unit 82 must withhold the impact force before they are engaged. And, the spur gears 71, 72, 73 and 74 and the power output unit 82 may be damaged.

To overcome this problem, a unidirectional clutch 6 is disposed between the power input unit 81 and the power output unit 82 in the prior art as shown in FIG. 2. When the power input unit 81 rotates clockwise, the power is transmitted to the power output unit 82 which rotates clockwise. Then, the power output unit 82 drives the spur gear 71 to rotate counterclockwise. When the actuation apparatus 7 rotates counterclockwise and prepares to switch the power from the power output unit 82 to the spur gear 72. As shown in FIG. 3, the spur gear 72 moves upwardly and engages with the power output unit 82 so as to drive the power output unit 82 to rotate clockwise. It is not necessary to overcome drag force of the first power source 8 and the gear train because of the unidirectional clutch 6.

FIG. 4 illustrates a conventional unidirectional clutch (or unidirectional bearing). When an outer ring 61 of the unidirectional clutch 6 rotates counterclockwise, a frictional component 62 does not drive an inner ring 63 to rotate. When the outer ring 61 of the unidirectional clutch 6 rotates clockwise (not shown), the frictional component 62 abuts against and drives the inner ring 63 to rotate clockwise. However, the unidirectional clutch needs more components and complicated assembly procedure so cost of the unidirectional clutch is high.

Reference is made to FIG. 5. FIG. 5 illustrates another type of unidirectional clutch in prior art. The unidirectional clutch 6 includes a rolling ball 64, an outer ring 65 and an inner ring 66. There is a clearance between the guide grooves 651 of the outer ring 65 and the guide grooves 661 of the outer ring 65, and the clearance has an unequal radius. When the rolling ball 64 enters the guide groove 651 of the outer ring 65 by gravitational force, the inner ring 66 rotates counterclockwise to drive the outer ring 65 to rotate by pushing the rolling ball 64 (or the outer ring 65 rotates clockwise to drive the inner 66 to rotate by pushing the rolling ball 64). However, the unidirectional clutch needs gravitational force to function in prior art. Thus, the unidirectional clutch will not normally function when it is placed horizontally. In addition, transmission lag sometimes happens to a mechanism with the rolling ball 64 and cost is high.

### SUMMARY OF THE INVENTION

It is an object of the present invention to provide a unidirectional clutch which uses minimal components to transmit power in one direction. Cost of the unidirectional clutch in this invention is lowered and assembly is simplified. No matter what the unidirectional clutch it is placed in any orientation, it functions normally.

To achieve object of the present invention, the present invention provides a unidirectional clutch including a power input unit, a power output unit, a contact mechanism and a torque resilient element. The power output unit and the power input unit are coaxially disposed. The contact mechanism is coaxially disposed between the power output unit and the power input unit. The torque resilient element is used to provide torque to the power output unit and the power input unit.

### BRIEF DESCRIPTION OF THE DRAWINGS

The present invention can be fully understood from the following detailed description and preferred embodiment with reference to the accompanying drawings, in which:

FIG. 1 is a perspective view of a transmission mechanism in prior art;

FIG. 2 is a perspective view illustrating how the transmission mechanism switches power in prior art;

FIG. 3 is another perspective view illustrating how the transmission mechanism switches power in prior art;

FIG. 4 is a perspective view of a unidirectional clutch in prior art;

FIG. 5 is a perspective view of another type of unidirectional clutch in prior art;

FIG. 6 is an exploded view of a unidirectional clutch according to the present invention;

FIG. 7 is a perspective view of a unidirectional clutch according to the present invention;

FIG. 8 is a perspective view illustrating how a unidirectional is implemented according to the present invention; and

FIG. 9 is another perspective view illustrating how a unidirectional is implemented according to the present invention.

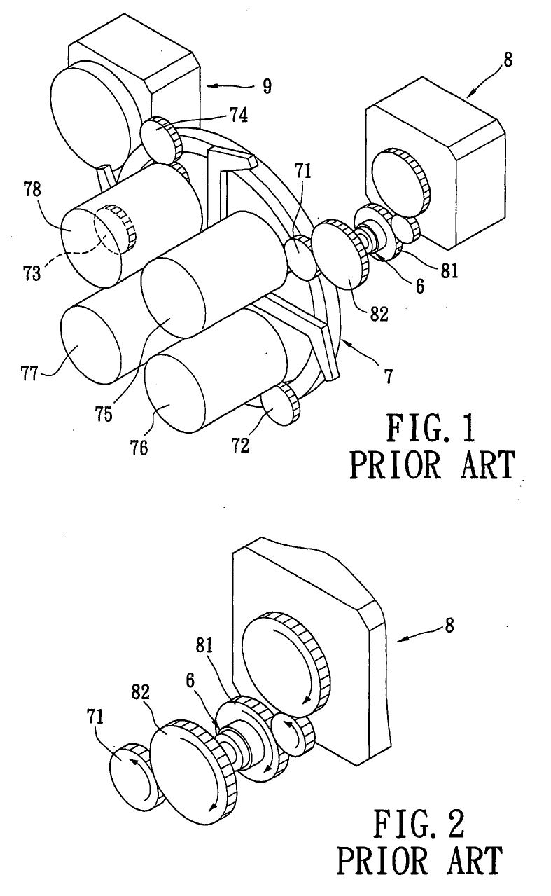

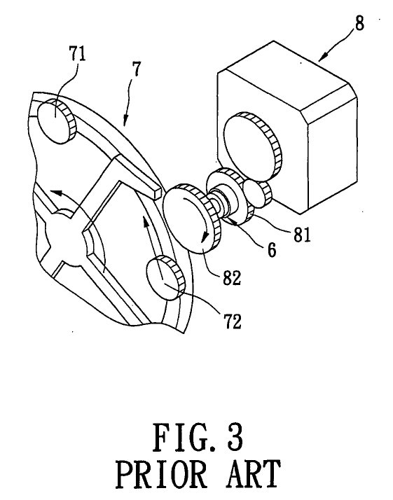

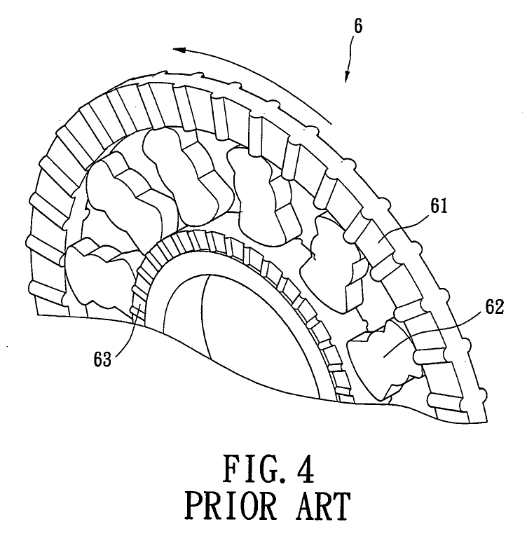

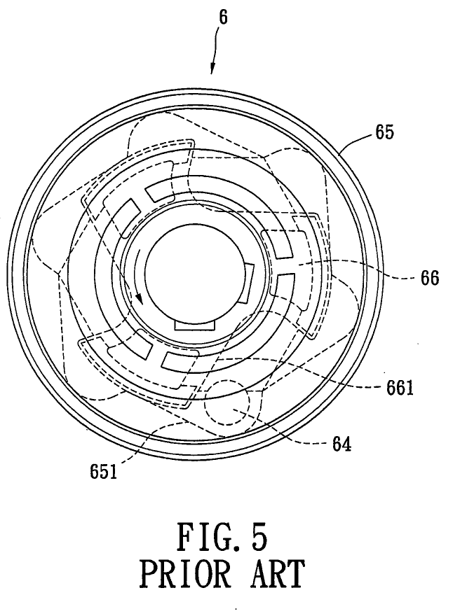

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

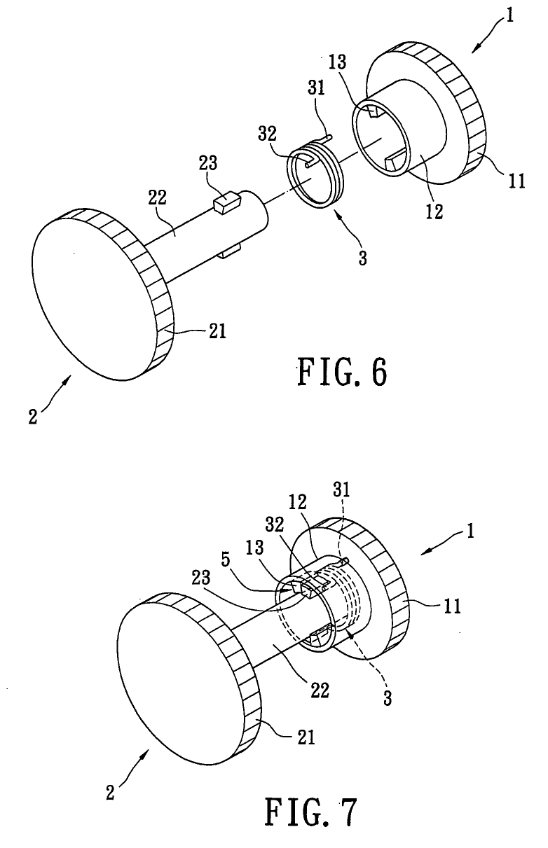

Reference is made to FIGS. 6 and 7. FIGS. 6 and 7 illustrate a unidirectional clutch of the present invention. The unidirectional clutch includes a power input unit 1, a power output unit 2 and a torque resilient element 3. According to the present invention, the power input unit 1 and the power output unit 2 are transmitting members, for example, spur gears, pulley etc. In this embodiment, the power input unit 1 includes a first spur gear 11 and an input shaft 12 extending longitudinally from a side of the first spur gear 11. The input shaft 12 is hollow and cylindrical, and at least one protuberance protrudes from inner surface of the input shaft 12. In this embodiment, two first protuberances 13 protrude from the inner surface of the input shaft 12 and are substantially separated by a certain degree, for example, 180 degrees.

The power output unit 2 includes a second spur gear 21 and an output shaft 22 extending longitudinally from a side of the second spur gear 21. The output shaft 22 is solid and cylindrical, and at least one protuberance protrudes from outer surface of the output shaft 22. In this embodiment, two second protuberances 23 protrude from an outer surface of the output shaft 22 and are substantially separated by a certain degree less than 360 degrees, for example 180 degrees.

However, the aforementioned embodiment is only illustrated to describe the prevent invention and is not limited therefore. For example, the input shaft 12 could be a solid shaft and the output shaft 22 could be hollow. The degrees between the protuberances are adjustable according to number of the protuberances in the invention.

The input shaft 12 of the power input unit I is adapted to receive the output shaft 22 of the power output unit 2 so that the power input unit 1 and the power output unit 2 are coaxially disposed. According to this embodiment, the two first protuberances 13 of the power input unit 1 abut against the second protuberances 23 of the power output unit 2 each other so that a contact mechanism 5 between the power input unit 1 and the power output unit 2 is formed. In this light, the power input unit 1 can rotate with respect to the power output unit 2 to a certain extent, and vice versa. Power of the first power source (not shown) is transmitted to an actuation apparatus (not shown) by interaction between the power input unit 1 and the power output unit 2. Thus, the power can be transmitted to the actuation apparatus in one direction by the unidirectional clutch of the present invention. According to this embodiment, the power input unit 1 can rotate with respect to the power output unit 2 by substantially 180 degrees, and vice versa. Nevertheless, the contact mechanism 5 is not limited to this but to any equivalent mechanism.

According to the present invention, the torque resilient element 3 is a resilient element which provides torque and has a first extension 31 and a second extension 32 at its two ends. The torque resilient element 3 is disposed between the input shaft 12 of the power input unit 1 and the output shaft 22 of the power output unit 2 so that the torque resilient element 3 are coaxial with the power input unit 1 and the power output unit 2. The first extension 31 of the torque resilient element 3 is firmly disposed at the power input unit 1, and the second extension 32 of the torque resilient element 3 is in contact with the second protuberance 23 of the power output unit 2. As shown in FIG. 7, the two second protuberances 23 of the power output unit 2 abut against the two first protuberances 13 of the power input unit 1, respectively. One of the second protuberances 23 is located between the first protuberance 13 and the second extension 32 of the torque resilient element 3, and is pushed to contact with the first protuberance 13 by the second extension 32. In this light, the torque resilient element 3 is disposed between the power input unit 1 and the power output unit 2. However, the first extension 31 of the torque resilient element 3 is not limited to be firmly positioned at the power input unit 1, but the second extension 32 of the torque resilient element 3 can be firmly connected with the power output unit 2. The essence of the present invention is making the power be transmitted toward a unique predetermined direction. The above-mentioned structure of the torque resilient element 3 and the relative position among the first protuberance 13 and second protuberance 23 and the torque resilient element 3 can not limit the scope of the present invention.

Reference is made to FIG. 7. When all gears of the actuation apparatus do not contact with the power output unit 2, the relative position between the power input unit 1 and the power output unit 2 is shown in FIG. 7. That is, the two second protuberances 23 of the power output unit 2 abut against the two first protuberances 13 of the power input unit 1 respectively so that the first power source (not shown) is ready for transmitting power to gears of the actuation apparatus (not shown). Thus, a torque outputted value of the torque resilient element 3 could be designed to just return the power output unit 2 to the position as shown in FIG. 7 without any loads.

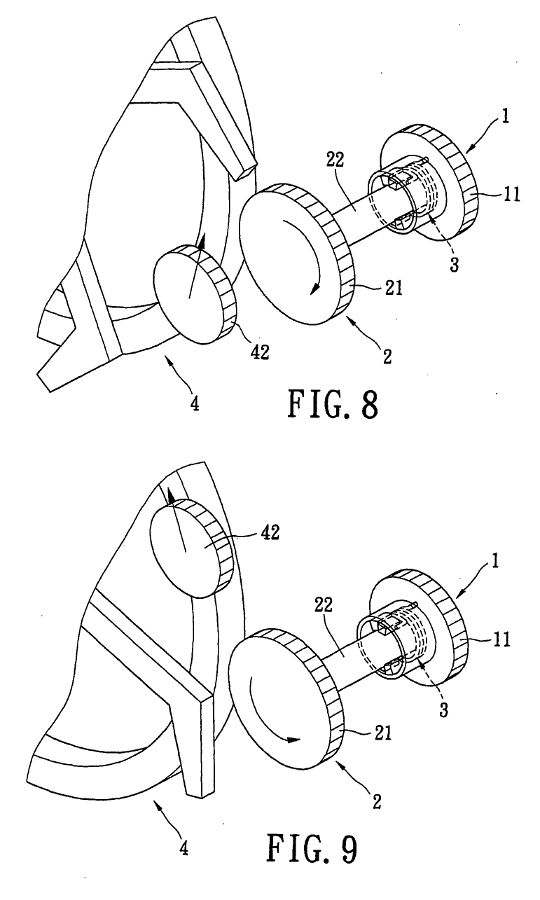

Reference is made to FIG. 8. During the period between the power output unit 2 is operated to engage with the actuation apparatus 4, an impact force between a spur gear 42 of the actuation apparatus 4 and the second spur gear 21 of the power output unit 2 is designed only to withhold the torque from the torque resilient element 3. In this regard, the power output unit 2 rotates clockwise as shown in FIG. 8. As shown in FIG. 9, when the actuation apparatus 4 is operated to separate the spur gear 42 from the second spur gear 21 of the power output unit 2, the torque resilient element 3 is utilized to return immediately the power output unit 2 to the driving position as shown in FIG. 7 by pre-determined torque. Even though the actuation apparatus 4 rotates continually and results in that the gears of the actuation apparatus 4 sequentially engage and disengage with the second spur gear 21 of the power output unit 2, the two second protuberances 23 of the power output unit 2 still do not push the two first protuberances 13 of the power input unit 1. Please note that number of the protuberances in this invention depends on a gear ratio between the spur gear 42 of the actuation apparatus 4 and the second spur gear 21 of the power output unit 2, and the degrees between the protuberances are adjustable according to number of the protuberances in the invention. Thus, the above engagement between the gears of the actuation apparatus 4 and the power output unit 2 of the present invention can prevent the adverse impact because of the drag force from acting and damaging on the gears.

According to the present invention, it provides a unidirectional clutch which uses minimal components to transmit power in one direction. Cost of the unidirectional clutch is lowered and assembly is simplified. No matter what unidirectional clutch it is placed in any orientation, it functions normally.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. A unidirectional clutch, comprising:
a power input unit;
a power output unit, coaxially disposed with the power input unit;
a contact mechanism, coaxially disposed between the power output unit and the power input unit; and
a resilient element providing torque to the power output unit and the power input unit and coaxially disposed between the power output unit and the power input unit.

2. The unidirectional clutch as claimed in claim 1, wherein the power input unit includes a first transmitting member and an input shaft extending longitudinally from the first transmitting member, and the power output unit includes a second transmitting member and an output shaft extending longitudinally from the second transmitting member, and the output shaft of the power output unit is rotatably assembled to the input shaft of the power input unit.

3. The unidirectional clutch as claimed in claim 2, wherein the input shaft is hollow and the output shaft is a solid shaft.

4. The unidirectional clutch as claimed in claim 2, wherein the input shaft is a solid shaft and the output shaft is hollow.

5. The unidirectional clutch as claimed in claim 2, wherein the torque resilient element is disposed between the output shaft of the power output and the input shaft of the power input unit.

6. The unidirectional clutch as claimed in claim 3, wherein a first protuberance extends from an inner surface of the input shaft of the power input unit, and a second protuberance extends from an outer surface of the output shaft of the power output unit so that the first protuberance abuts against the second protuberance to form the contact mechanism.

7. The unidirectional clutch as claimed in claim 6, wherein the power input unit has at least one first protuberances and the power output unit has at least one second protuberances.

8. The unidirectional clutch as claimed in claim 6, wherein the power input unit has two first protuberances and the power output unit has two second protuberances.

9. The unidirectional clutch as claimed in claim 8, wherein the two first protuberances extend from the inner surface of the power input unit and are separated by a predetermined degrees, and the two second protuberances extend from the outer surface of the power output unit and are separated by a predetermined degrees.

10. The unidirectional clutch as claimed in claim 9, wherein the predetermined degrees is less than 360 degrees.

11. The unidirectional clutch as claimed in claim 2, wherein the transmitting member is a spur gear.

12. The unidirectional clutch as claimed in claim 2, wherein the transmitting member is a pulley.

13. The unidirectional clutch as claimed in claim 1, wherein the resilient element is coaxially disposed between the power input unit and the power output unit, and one extension of the resilient element is firmly disposed at the power input unit and the other extension of the resilient element is in contact with the power output unit.

14. The unidirectional clutch as claimed in claim 13, wherein the other extension of the resilient element is in contact with the second protuberance of the power output unit.

15. The unidirectional clutch as claimed in claim 1, wherein the resilient element is coaxially disposed between the power input unit and the power output unit, and one extension of the resilient element is firmly disposed at the power output unit and the other extension of the resilient element is in contact with the power input unit.
